(19) United States
(12) Patent Application Publication
(10) Pub. No.: US 2015/0235304 A1
(43) Pub. Date: Aug. 20, 2015

(54) METHOD AND SYSTEM FOR GLOBAL SHOPPING AND DELIVERY

(71) Applicant: Melissa M. Vincent, Beverly Hills, CA (US)

(72) Inventor: Melissa M. Vincent, Beverly Hills, CA (US)

(21) Appl. No.: 14/622,852

(22) Filed: Feb. 14, 2015

Related U.S. Application Data
(60) Provisional application No. 61/940,302, filed on Feb. 14, 2014.

(51) Int. Cl. G06Q 30/06; G06Q 30/02

(52) U.S. Cl. CPC G06Q 30/0641; G06Q 30/0633; G06Q 30/0261; G06Q 30/0623; G06Q 30/0222

(57) ABSTRACT

A global delivery system comprises: a customer global delivery system access device having installed therein a global delivery system app, the customer global delivery system access device further having Internet access functionality for initiating a commercial establishment and service provider shopping event using the global delivery system app; the global delivery system app having access to a global delivery system database of merchants participating in the global delivery system; a global delivery server storing the global delivery system database; and at least one merchant terminal providing a merchant website.

### CROSS REFERENCE TO RELATED APPLICATION

The present Application is related to Provisional Patent Application entitled “Method and system for global shopping and delivery,” filed 14 Feb. 2014 and assigned filing No. 61/940,302, incorporated herein by reference in its entirety.

### FIELD OF THE INVENTION

The present invention relates generally to a system for enabling commercial establishments such as physical stores, department stores, retail stores, grocery stores, pharmacies, drugstores, restaurants including fast food in the world to all have an individual online presence independently and under a single roof with custom delivery capability by allowing these entities to share links and information, use its white label store apps and websites, integrate the global delivery API into their websites or download their stores' content to the useful, novel and unobvious global shopping and delivery app and app website regardless if they have a current online presence or never had an online presence before.

### BACKGROUND OF THE INVENTION

Health issues, lack of readily available support system and lack of financial resources to afford a maid or a caregiver can impair one's access to immediately needed merchandise, food or services, especially in times of sickness or just in times of need, thereby potentially resulting in negative outcomes. Sometimes, one simply is too busy or would rather do something else with one's time than having to travel to obtain merchandise from the store oneself.

One objective of the present invention is to enable physical stores, such as department stores, grocery stores, supermarkets, hypermarkets, retail stores, boutiques, pharmacies, home-based businesses, restaurants including fast food restaurants, and coffee shops etc. to all have an individual online presence, both independently and under a “single roof,” by allowing these entities to download their stores' content to the app and app website regardless if they have a current online presence or never had an online presence before. This system basically serves as a deliverer and virtual landlord for physical businesses by providing white label store apps and websites for stores of any size, along with an independent and/or dependent and integrated website and ordering platform for stores, including department stores, grocery stores, retail stores, pharmacies, restaurants, coffee shops and fast food establishments, whether or not the establishment has a web presence.

The app's own API can also be integrated into the website of a store with an existing online presence so that users can order directly through the store's website and at the same time access the Global Delivery System for a prompt and custom delivery from the same screen/a single screen. This can also be done via shared shopping and delivery links. Businesses also have a choice of providing their own delivery, covering all or a part of the delivery fee for their clients.

This provides the establishments with an effective online presence and integrated ordering platform to search the establishment, whether the store is small or large. With this, essentially every establishment can have an online presence for considerably less than would cost to establish if done on their own. In the absence of a website, customers can order via a communication device such as a telephone or a mobile communication device. The customers will be able to purchase and order goods from essentially any store, and would not be limited in their choices, unlike the present state of the art wherein a customer is limited to purchasing from stores having an online presence. Home-based business owners can choose to bring ordered items to Global Delivery Centers for immediate or same-day delivery or a Global Delivery personnel/driver can pick them up.

This way, store owners including grocery store owners, pharmacy/drug store owners, retail store owners, restaurant owners, fast food owners and coffee shop owners who were not able to offer delivery before because they could not afford to hire a delivery worker will be able to offer delivery via the present invention. Likewise, store owners, including grocery store owners, pharmacy/drug store owners, restaurant owners or fast food owners who struggled to hire a delivery man just for the purpose of delivering, will no longer have to do so. They will obtain this advantage along with the advantage of heavy business exposure the present invention offers and therefore boosting their revenues. The disclosed invention includes an app that does your shopping for you, so you don't have to and delivers the merchandise ordered in a timely manner according to your request as the user. Store owners also have a choice of providing their own delivery if they prefer.

Among the shortcomings with systems such as Amazon, eBay and others is that, while these allow users to order certain merchandise online, the earliest they arrive is two days later or at the most rapid, the next day. Therefore, these systems do not address the “need-it-right-now” issue. Also, users are limited in what they can order online since these sites do not offer all the items users are likely to require. In addition, their services are only online, which means if someone were to need some groceries at the local grocery store, this person would have to physically go to the grocery store to get groceries. Also, users may be obliged to pay outrageous delivery fees for the items they purchase.

In standard practice, one could just call in an order or use an app with just an order and payment form without all the extra convenience that could be considered optional; but this would make the task much harder and even such a simple option is nonexistent at present. As we are in a time of innovation and as ease of use is paramount to customer satisfaction, the disclosed inventive software/app is just the right tool for the present market and it incorporates regular updates to match technology advances, so as to always be relevant.

An option restricted to telephonic ordering or an app with just an order and payment form would take too much of the user's time although they are also both included as options in this innovative software/app along with specific disability option so that each disability that could possibly impair users' access to the innovative app is accounted for and/or has its own allocated interface or section.

Also, users have the options to either pick up their merchandise or have it delivered to them. If users choose to pick up their merchandise, their merchandise will be prepared and packaged according to users' directives and pickup schedule. The pickup option still saves the user the considerable amount of time they would otherwise spend shopping for their merchandise going from aisle to aisle, wait in line to pay for their merchandise and have them bagged. With the pickup option, the user would have already selected, ordered and paid for their merchandise using the global shopping and delivery system before picking up their merchandise. A market can also choose to offer free delivery to their clients via the Global delivery system and therefore covers the delivery fee for their clients on a temporary or permanent basis.

### BRIEF SUMMARY OF THE INVENTION

In one aspect of the present invention, a global delivery system comprises: a customer global delivery system access device having installed therein a global delivery system app, the customer global delivery system access device further having Internet access functionality for initiating a commercial establishment and service provider shopping event using the global delivery system app; the global delivery system app having access to a global delivery system database of merchants participating in the global delivery system; a global delivery server storing the global delivery system database, the global delivery server in communication with the customer global delivery system access device via the Internet; and at least one merchant terminal providing a merchant website, the merchant website having an integrated global delivery system API for responding to the commercial establishment and service provider shopping event using the global delivery system app, the global delivery system API enabling a customer to access the global delivery system app directly on a merchant order entry web interface so as to provide the customer with access to selected merchant items.

In another aspect of the present invention, a method of executing a global shopping event by a customer comprises the steps of: accessing a global delivery system database of commercial establishments and service providers located throughout the world; determining the geographic location of the customer using a global delivery system app; analyzing the global delivery system database to generate a plurality of said commercial establishments and service providers that are proximate to the geographic location of the customer; displaying to the customer the plurality of commercial establishments and service providers using the global delivery system app; selecting at least one of the commercial establishments and service providers as being of interest to the customer; and reviewing a plurality of items and services offered by at least one of the commercial establishments and service providers of interest using the global delivery system app.

In still another aspect of the present invention, a method of executing a global shopping event by a customer comprises the steps of: accessing a global delivery system database of commercial establishments and service providers located throughout the world; determining the geographic location of the customer using a global delivery system app; entering at least one item desired for purchase using the global delivery system app; retrieving a plurality of the commercial establishments and service providers that are proximate to the geographic location of the customer in response to the step of entering; selecting at least one of the commercial establishments and service providers as being of interest to the customer; and reviewing a plurality of items and services offered by at least one of the commercial establishments and service providers of interest using the global delivery system app.

The additional features and advantage of the disclosed invention is set forth in the detailed description which follows, and will be apparent to those skilled in the art from the description or recognized by practicing the invention as described, together with the claims and appended drawings.

### BRIEF DESCRIPTIONS OF THE DRAWINGS

The foregoing aspects, uses, and advantages of the present invention will be more fully appreciated as the same becomes better understood from the following detailed description of the present invention when viewed in conjunction with the accompanying figures, in which:

FIG. 1 is a diagrammatical illustration of a global delivery system, in accordance with the present invention; and

FIG. 2 is a flow diagram illustrating operation of the global delivery system of FIG. 1.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention. The invention relates generally to a computer and mobile device implemented process, a readable, writable, executable, intuitive, user-friendly, interactive, native and/or cross-platform medium/software application (aka “app”) optimized for multi-platform, a system for providing an interface whose end-purpose is to allow a customer access to system used for ordering and receiving immediate or delayed delivery of ordered services and merchandise from any physical store including department stores, grocery stores, pharmacies, local restaurants, coffee shops and fast-food restaurants in the USA and worldwide.

A disclosed computer and cross-platform and/or native mobile app allows users to instantly order services and goods from their (favorite) local stores, including grocery stores, local restaurants, including take-out, coffee shops and fast-food restaurants near them in the USA and throughout the world for immediate (within minutes) or delayed delivery.

By allowing users to seamlessly order goods, food and services via their computer or mobile device or telephone, users can purchase any merchandise (including medications) from any local store, local grocery stores, local pharmacy, local restaurants including take-out, coffee shops, fast food restaurants wherever they are in the world and receive it within minutes, hours or days at the destination of their choice and according to their preferences, this software will improve access to needed goods, save users a considerable amount of time and prevent lack of support systems and/or lack of financial resources from impairing users' access to needed merchandise and therefore resulting in happier outcomes and happier lives.

The software is extremely intuitive and user-friendly and can be used by everyone including the deaf, visually impaired, physically impaired and vocally impaired user. Using the software is like going shopping, buying clothes, buying groceries, buying medications, fill out prescriptions, buying cooked food and having them carried to your home immediately without actually leaving your home. This system allows a customer access to a database of local stores (including those in shopping malls), local grocery stores, local pharmacies, and drugstores, local restaurants, including fast-food restaurants and coffee shops for the purpose of shopping, ordering, and receiving delivery of ordered merchandise within minutes, hours or days depending on their preferences.

In the absence of a database or if the customer chooses to bypass the database, the customer can phone their order in right from the application by typing in desired product(s) and information where the product can be purchased for the purpose of purchasing the product(s) and having it/them delivered within minutes, hours or days at the destination of their choice and according to their preferences. Users will have the option to input an exact date, day and time or approximate time they want to receive their delivery. This invention offers the customer an experience similar to physical shopping, except that it is better in that the customer does not have to spend time, gas, wait in traffic, pay a taxi, take the bus or carry the merchandise.

Previously, individuals who could not physically travel to stores themselves to get something they need immediately and who had no one to do it for them were obliged to suffer the consequences of not having access to what they needed, often resulting in starvation, frustration, sickness, anxiety, depression, etc. This software fills this void and provides such individuals, as well as consumers in general, with a simple solution that enhances their ability to access goods and services without delay.

This software not only allows inexpensive, intuitive and within-minutes delivery, but also allows users to order anything they desire, as long as it is available in the store(s). Currently, there are a few restaurant-food ordering applications on the market; however, not only is their function restricted to restaurant ordering, but also, they do not provide direct delivery. Instead, they just take the order and the restaurant carries out the delivery. This software takes care of both the order and delivery for the fastest possible delivery outcome. Users have the option to phone in their order right from the application and users have the option to choose the simpler pickup option.

Users who do not have access to a mobile device or a computer device can phone in their order. For added convenience, the software allows users to schedule in advance the delivery of selected merchandise to arrive at designated places, dates and times. Users can place an order with a single store or with multiple stores or they can place many orders with one store and/or multiple orders with multiple stores. Users can choose to order a single item such a light bulb or a cup of coffee for example or multiple items. Also, users can schedule repeated delivery of the same order or different orders at selected/chosen intervals i.e. daily, twice a week, weekly, bi-weekly, or monthly, with no further action needed on their part.

The app provides a white label store apps for stores of any size, along with an independent and/or dependent and integrated website and ordering platform for stores, including grocery stores, pharmacies, restaurants, fast food and take out establishments, whether or not the establishment has a web presence.

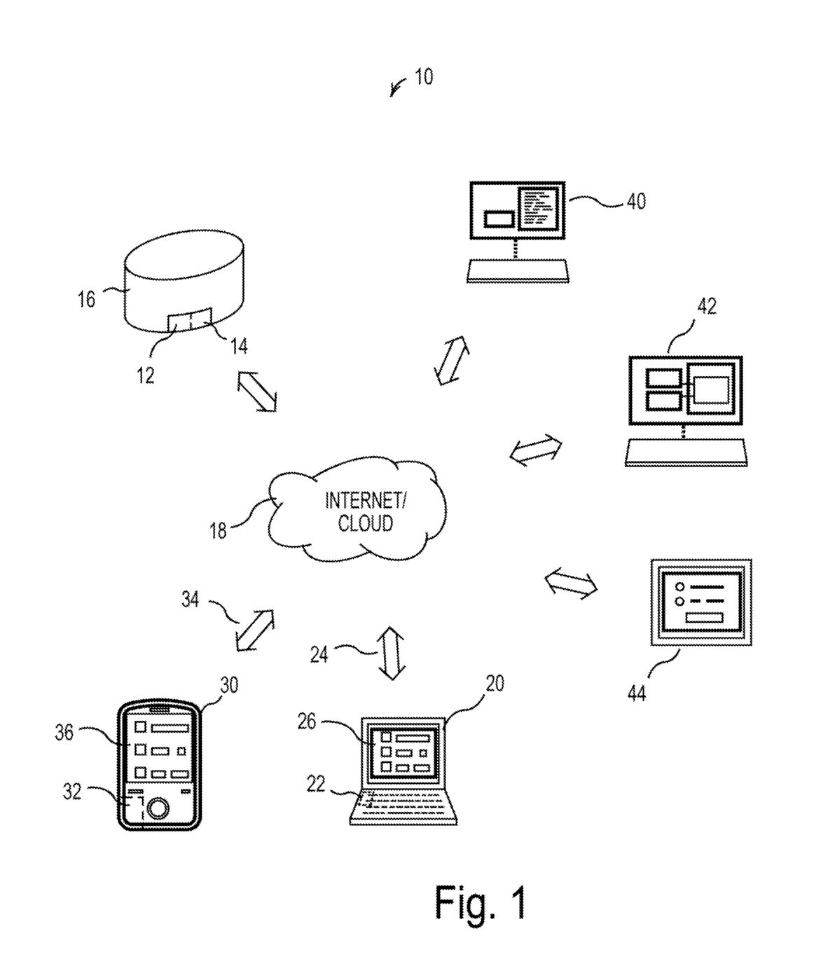

There is shown in FIG. 1 a global delivery system 10, in accordance with the present invention. The global delivery system 10 functions in accordance with a global delivery system application 12 and a global delivery system database 14 resident in a global delivery server 16. The global delivery system database 14 contains commercial establishments, including service providers, collectively referred to herein as “merchants,” throughout the world. A customer uses a global delivery system access device having installed therein: (i) Internet access functionality; and (ii) a global delivery system app, as described in greater detail below. The global delivery system app disclosed herein enables the global delivery system access device to operate within the global delivery system 10 for initiating a shopping event at a selected global commercial establishment or service provider, i.e., merchant, and tracking delivery of one or more purchased items or services.

A customer may select a computer-based communication device, such as a customer computer 20 and/or a customer mobile communication device/tablet 30, as a global delivery system access device by which to access the global resources available through the global delivery system application 12. The customer computer 20 and the customer mobile communication device/tablet 30 may operate by means of a touchscreen, as is known in the art. In an exemplary embodiment, the customer may choose to download and install a PC Global Delivery System App, herein referred to as a cross-platform PC Delivery System Software Application and Database (DSSAD) 22, into the customer computer 20.

A mobile communication device user may choose to download and install a Mobile Global Delivery System App, herein referred to as a Mobile Delivery System Native/Cross-Platform Software App and Database (DSNSAD) 32, into the customer mobile communication device 30. The PC or mobile or tablet app is thereby installed for the purpose of ordering merchandise from a commercial establishment, or merchant, found in the global delivery system database 14 for quick or immediate delivery. The customer computer 20 may communicate with the Internet 18 via a PC link 24, and the customer mobile communication device/tablet 30 may communicate with the Internet 18 via a mobile link 34.

The PC DSSAD 22 and the Mobile DSNSAD 32 software apps house a database of merchants listed in the global delivery system database 14 and participating in the global delivery system 10, as well as merchants who are not registered for participation in the global delivery system 10. The PC DSSAD 22 and the Mobile DSNSAD 32 software apps also provide access to the global delivery system database 14 for a user. The participating and non-participating commercial merchants may include, for example: department stores, retail stores, grocery stores, pharmacies, restaurants, fast-food restaurants, coffee shops and a network of participating merchants including department stores, retail stores, grocery stores, pharmacies, restaurants, fast-food restaurants, coffee shops as described in greater detail below.

Participating stores and merchants may access a respective merchant terminal having Internet access functionality for responding to the customer-initiated shopping event. This may include: (i) having a link to the respective merchant website, (ii) providing a link to a stationary spot, or (iii) providing the user access to selected merchant products, including access to the entire inventory of the merchant store. The user may access the inventory directly via the PC DSSAD 22 and the Mobile DSNSAD 32. Participating stores with online presence can have the Global Delivery System API integrated into their respective website so that users can access the same Global Delivery System Application directly on the store's order entry web interface.

Once downloaded, the PC DSSAD 22 and the Mobile DSNSAD 32 display respective interfaces 26 and 36 from which the users may choose. For example, the customer computer 20 interface 26, or the customer mobile communication device 30 interface 36, may display: (i) “I am a shopper”; (ii) “I am an affiliate”; or, (iii) “I am an associate” (which can further display subsections for drivers, clerks, dispatchers, managers, or administrators). The interfaces 26, 36 work to provide the customer with the ultimate shopping experience with fast, intuitive and user-friendly ordering (online, offline, manually, vocally etc.). The PC DSSAD 22 and the Mobile DSNSAD 32 are intuitive and allows normal ordering and selection within a certain physical distance, thus providing geographical proximity.

If a store does not have a database available in the Global Delivery System Application 12, the customer may either select or manually input the store information along with the needed merchandise, placing an order manually, vocally or by using any other means adequate and compatible. Users can also phone in their orders directly via the Global Delivery System Application 12, or from their personal phones. Users can pay for their orders directly via the Global Delivery System Application 12, via an alternate payment method, or via a merchant store website. Users can also order directly via a store website, which easily synchronizes with the (integrated) Global Delivery System Application 12, so that local users can receive merchandise ordered, essentially immediately.

The PC DSSAD 22 and the Mobile DSNSAD 32 allow users to effortlessly instruct how their delivery is to be made (e.g., left at the door—no signature required, hand delivered to any person or to a designated person with delivery signature, or confirmation)—and monitor their order's trajectory from processing to end delivery, right from the screen of the customer computer 20 or of the customer mobile communication device 30, by allowing status monitoring of completed order (e.g., placed received fulfilled/ready en route arrived delivered), with every process time stamped.

The customer global delivery system access devices may be provided with Wi-Fi or Wi-Fi alternatives, and/or data and audio input and output access and capability, a camera, a media player capable of allowing recording and playback, video chat functions, video playing capabilities, picture upload/download, and may be GPS-enabled.

The customer global delivery system access devices include readable, executable, intuitive, user-friendly native and/or cross-platform medium/applications comprising the PC DSSAD 22 or the Mobile DSNSAD 32, with accompanying web applications/website sharing the same ordering touchscreen or non-touchscreen interface that incorporates location and/or sensor APIs, data, video & audio input features and text-voice-video chat features, voice-to-text recording capability, text-to-voice playing capability/voice command with data and audio-output and input capability to and from the computer 20 or the mobile communication device 30, and/or Voice over Internet Protocol (VoIP), integrated data capture devices, Instant Messaging (IM), Electronic Mail and/or touchscreen graphical customer interface GUIs.

The customer global delivery system access devices may include data and audio input and output accesses and features, image and graphic input, and output accesses and features, voice-to-text recording capability, and text-to-voice playing capability/integrated audio player/voice command with the capability of taking and repeating the orders to users.

The customer global delivery system access devices may further include microphone, speaker, Internet Wi-Fi access and photo or video input or output, monitor, computer keyboard, mouse, trackball, or other manually, vocally, or sense-enable and user-interactive interfaces for controlling on-screen cursor activity, and perhaps an optional headphone or headset.

Database(s) of stores, products, customers, customer reviews, customer surveys and orders per city or state or country depending on market size, may be included in the customer global delivery system access devices. Multiple servers (including. cloud servers) or any similar or compatible future technology may house the Global Delivery System Application 12 along with its memory and the integrated database per city, state, region, country, continent, forming one network across the globe, so that the content always originates from the server closest to the customer choice of created technology. There may further be provided other existing technology, such as Content Distribution Networks (CDNS), or load balancing for data routing management.

The computer peripherals/gadgets (e.g., microphone, speaker, Internet/Wi-Fi access and photo or video input or output, monitor/display, computer keyboard or touchscreen, mouse or other manually, vocally, or sense-enable and user-interactive interface for controlling on-screen cursor activity, headphone, headset, may be connected to a computer or integrated into a mobile device with touchscreen, Wi-Fi and/or data, video and audio input and output access and capability (1) work together with the computer and mobile device readable, executable, intuitive, user-friendly and cross-platform medium/application (the Global Delivery System Application 12), (2) to enable users to search for, visualize, select desired items from the database of shops within or outside a geographical proximity, pay/submit their order for ultra-fast and immediate delivery and monitor their order's trajectory right from the computer 20 or from the screen of the mobile communication device 30.

The data and audio input and output accesses and features, voice-to-text recording capability and text-to-voice playing capability/integrated audio player/voice command with the capability of taking and repeating the order to users, and the database (s) of stores, products, customers and orders per city or state or country depending on market size are all integrated into the software/app and housed by multiple servers forming one network across the globe that are managed either by created technology, existing technology, Content Distribution Networks (CDNS) or load balancing for data routing management.

Once all setup is complete, that is, once the software/app is downloaded into a working computer or a mobile device with the specifications mentioned above, the global delivery system application 12 is ready for use.

Feature 1—In an automated mode, the Global Delivery System Application 12 may automatically locate the user's current location with the user's permission or the customer can input the exact desired delivery location or just input the desired delivery location zip code.

Feature 2—In the automated mode, the Global Delivery System Application 12 may display all local stores, local pharmacies, local grocery stores, local restaurants including fast food and take out restaurants in the user's current location. If users input a different location, the Global Delivery System Application 12 may display all local stores, local grocery stores and local restaurants, including fast-food restaurants in the user-inputted location.

Feature 3—Users can also input the desired product/merchandise and app will display all the different brand and varieties available for that particular product/merchandise along with all the local stores where that product can be found. Users can select the desired item by adding it or by dragging it to their basket/cart.

Feature 4—Users may choose the desired store and start putting merchandises in their basket/cart. In the example provided, the customer may choose to access one or more of, for example: (i) a grocery store, represented by a grocery store terminal 40; (ii) a restaurant, represented by a restaurant terminal 42, and a fast food establishment, represented by a fast food employee computer tablet 44.

Feature 5—When a customer inputs a desired item, and local stores with an available database of merchandise are displayed on the user's screen, the customer can select the desired store where the merchandise is to be purchased or just input or select a favorite local store at the beginning of the shopping procedure.

Feature 6—If a desired store within a determined geographical proximity does not have an available database of merchandise, the customer may input the information for the store and the order desired, along with a picture of the desired items if the customer chooses to include these. If a desired store is outside a normal ordering geographical area, the customer can still choose to order the item, but its delivery might take longer and be more expensive.

Feature 7—Users have the option to phone in their orders right from the Global Delivery System Application 12, or from their personal telephone. This is to enable: (i) elderly people, (ii) ill people, (iii) people who just prefer to order via phone, and (iv) people who are not computer literate to use and benefit from the global delivery system 10.

Feature 8—Users have the options to order as if they were physically in the store such as specifying; (i) per pound, (ii) quantity, (iii) color, (iv) brand, (v) organic, (vi) regular/conventional, etc.

Feature 9—Users can specify how delivery is to be accomplished, as explained above.

Feature 10—Users can program future delivery(ies), as users wish, along with future payment(s).

Feature 11—Users pay for the delivery using accepted forms of payment, place their order, and monitor their order trajectory until its end-delivery. Users can also request a specific associate to fulfil their order.

Feature 12—Upon delivery, users have the option to take a short survey that will serve to improve the quality of service.

Feature 13—Users can rate service(s) received upon delivery and write comments, report problems, or make suggestions in their survey and/or post them in blogging areas.

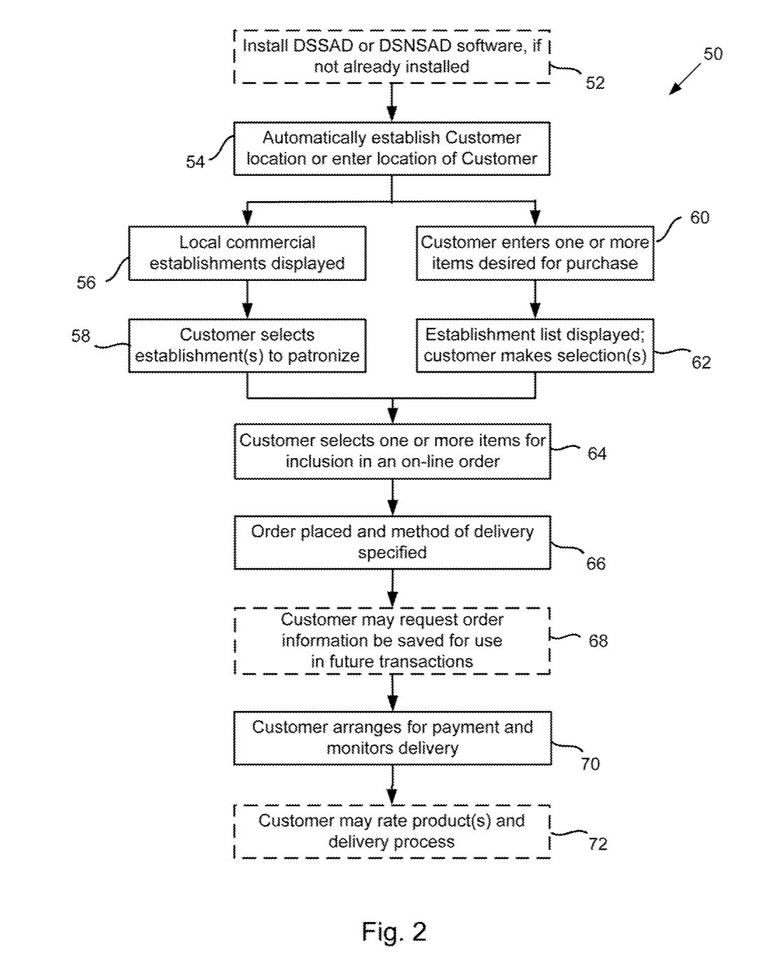

The flow diagram 50, shown in FIG. 2, may be used to explain the method for using the global delivery system 10. After a user or customer has downloaded or installed the PC DSSAD 22 (i.e., the PC delivery system app) or the Mobile DSNSAD 32 (i.e., the mobile delivery system app), at step 52, the customer may initiate the procedure to order merchandise either for prompt delivery or for future delivery, or the customer may just want to play a game that comes with the PC DSSAD 22 or the Mobile DSNSAD 32. The customer may have the option of ordering as a registered customer or simply as a guest user.

The Global Delivery System Application 12 may take care of seamless registration by allowing guest users an automatic registration option as they are inputting their orders and/or automatic login via using their social media login credentials. For example, logging in using their Facebook or Twitter account. Customers have the option of using a pseudonym, their real names, and other means of identification or a combination of these. They can also choose to upload a picture of themselves, an avatar or no image at all, and post their favorite catchphrase, signature or quote in their public profile, or other favorite items. They can choose to give their phone number or e-mail address for communication about their order, new products, articles, coupons, and promotions, for example.

After the PC DSSAD 22 or the Mobile DSNSAD 32 is ready for use, the customer may use the intuitive and user-friendly interface 26, 36 to place their desired order(s) and make payment by following simple steps.

At step 54, the PC DSSAD 22 or the Mobile DSNSAD 32 automatically locates the user's current location with the user's permission, or the customer can input the precise desired delivery location, or just input the desired delivery location zip or postal code. The global delivery system application 12 returns a plurality of that are proximate to the location of the customer.

For example, by using an “I am located in” tab,' the customer has the choice of: (i) inputting a zip code with the rest of the information populated by the program; (ii) entering a region with the screen then displaying countries from which the customer may select; (ii) entering a country with the screen then displaying states from which the customer may select; (iii) entering a state with the screen then displaying cities from which the customer may select; and (iv) entering a city with the screen then displaying stores within that city including affiliates, at step 56, from which the customer may select. The customer may then select from the list of displayed establishments, at step 58, in the process of searching for the item(s) desired.

Alternatively, with the permission of the customer, the PC DSSAD 22 or the Mobile DSNSAD 32 may display all local stores in the user's current location. If the customer inputs a different location, the PC DSSAD 22 or the Mobile DSNSAD 32 displays all local stores, local grocery stores, local pharmacies, local restaurants, including fast-food restaurants in that location.

In a non-automated mode, the customer can search stores and affiliates by zip code, country, city, street, store name, neighborhood or a point of reference using the PC DSSAD 22 or the Mobile DSNSAD 32. When the customer starts inputting an address, an automatic pop-up suggests multiple addresses for the customer to choose from. When the customer inputs a zip code, the corresponding state, city, and region automatically fill in. Of note, the customer can also input multiple addresses in their profile for billing and/or delivery. They can also use available filters to search for desired stores, products, location etc.

Once the customer has entered an address, the stores within a specified distance, such as a preset or a set of miles, are displayed on the user's screen including the stores' affiliates, with stationary or uploaded database, or link to the affiliates' websites so that the customer can make a selection.

Users can also input the desired product/merchandise/food, at step 60. The PC DSSAD 22 or the Mobile DSNSAD 32 will display all the different brands and varieties available for that particular product/merchandise along with all the local stores where that product can be found, at step 62. The customer may choose the desired store and start selecting desired merchandise and putting items in a virtual shopping cart, at step 64. As known in the art, UPC Bar code scanner enable a store or commercial entity to easily add specific items to their shelves for display. Likewise, for faster results, users can choose to add UPC-coded items to their search inquiry or order using the integrated virtual Bar code scanner to scan directly from a physical item instead of inputting the information manually.

A user can virtually add/select a product for purchase, using the PC DSSAD 22 or the Mobile DSNSAD 32, by dragging the virtual product from the virtual shelf to their virtual shopping cart, or by scanning the product's UPC Bar code if the user is in possession of an actual container or a tag. The PC DSSAD 22 and the Mobile DSNSAD 32 allows a user to also scan/add/upload store brand items. For store brand items and for foreign countries products, the user may have initially performed a one-time scan and/or data entry that will serve as a basis for future recognition, if the desired item is a store-specific item or if the item is not recognized by the global delivery system 10.

A single subscription can be used by multiple users, or by one principal user and multiple secondary users. All multiple users, principal users, and secondary users can synchronize across respective communication devices. For example, one family member may be selected as the principal or primary user/shopper. This principal user may be the head of a household, or a person usually in charge of buying groceries. Other users within the same or different subscriptions can create their own shopping lists, with their own choices of items, and synchronize their respective lists with the list of the principal user. Synchronized items can be displayed to all as highlighted or color coded items. All subscribed users regardless of their location can synch lists between parties if all parties are in agreement.

The principal user can synchronize his/her list with the other users' lists, and may also have the ability to move, delete, modify, approve, and disapprove of items on another user's shopping list, using the PC DSSAD 22 or the Mobile DSNSAD 32. Multiple users can also access the main user's list and choose to enter item into the main user's list. Added items have distinguishing characteristics that allow the main user to see which items are added along with info on who added the additional item(s). In an exemplary embodiment, this feature allows a mother to disregard an item she does not want her child(ren) to have, or to move the disregarded item to a wish list, or to save the removed item for a later time. For example, a daughter enters selected items via her phone, while the mother enters her selection of items via her computer. Both mother and daughter can synchronize their respective lists and obtain the items both have selected. Alternatively, the mother can remove one or more items that the daughter had added, and the PC DSSAD 22 may automatically synchronize or manually combine the two lists into a single order.

All users can also set up reminders. Users, principal users, and secondary users can also share their respective grocery lists internally and externally to the global delivery system 10 and other outlets or social networks. The principal user can also send his/her list to one or more other users, so that they can add their selection of items to the list held by the principal user. In this case, the principal user's list would show the added items in highlights or in color codes or any other distinguishing features desired and available. The PC DSSAD 22 and the Mobile DSNSAD 32 also enable secondary users to pay for their share of groceries/goods/food. Users can also split the cost of items as they wish and pay using one or multiple forms of payments.

In an exemplary embodiment, the PC DSSAD 22 and the Mobile DSNSAD 32 may provide users with coupons pages that automatically screens and synchronizes with items on the respective user's list. This action enables a user to automatically take advantage of a coupon or a discount being offered, so that the user does not have to remember to add a particular coupon, or to keep tab on a coupon's expiration date.

When a customer inputs a desired item, local stores, local pharmacies, local grocery stores, local restaurants, including fast-food restaurants nearby that offer the desired item may be displayed on the user's screen or read to user. The customer can select the desired store where the merchandise is to be purchased, or just input or select a favorite local store from the beginning of the online process. The order may then be placed, and a method of delivery may be specified, at step 66.

It can be appreciated that the PC DSSAD 22 and the Mobile DSNSAD 32 are “color-blind friendly” and “poor-vision friendly.” The user can also assign a name to a particular shopping list, where the PC DSSAD 22 and the Mobile DSNSAD 32 “remember” the user's usually-ordered items, and may automatically complete a user's item selection entry on a display screen via suggestions, and keeps checked-off items isolated but tags the items for future recall if needed. The user can “drag” items into categories. Alternatively, the PC DSSAD 22 or the Mobile DSNSAD 32 may operate in an automated mode so as to sort items by category (e.g., veggies, dairy, meats, gluten-free, underwear, shoes, etc.). The PC DSSAD 22 and the Mobile DSNSAD 32 offer editing-free and fluid quantity change. A user can request to be sent alerts about sales in his/her favorite stores.

If a desired store that is within the determined geographical proximity does not have an available database of merchandise, the customer may input the information for the store, and the specifications of the order desired, along with pictures of the items if the customer chooses to include this information.

Users have the option to phone in their orders right from the PC DSSAD 22 or the Mobile DSNSAD 32, from the Global Delivery System Application 12 website, or from a personal telephone. This enables elderly or ill people, people who just prefer to order via phone, or people who are not computer literate, to also use and benefit from the global delivery system 10.

As described above, customers have the options to order as if they were physically in the store, by specifying: per pound, a quantity, a color, a brand, if organic, if all-natural, and to select how delivery is to be made.

A registered customer can save order(s) and/or schedule future orders. The registered customer can program future delivery(ies), along with future payment(s), at step 68. The registered customer can access past orders saved for easy reordering. They can save their shopping list(s) and their favorite store(s) for future referrals. There may also be a display of stores and items viewed along with past orders and suggested products at the bottom their screens.

Users may pay for their delivery using accepted forms of payment, place their order, and monitor their order trajectory until its end-delivery, at step 70. For example, payment methods such as certificates, vouchers, points, funds reserve, credit cards (including merchant credit cards), and credit cards offered by the Global Delivery System, PayPal, Stripe, checking accounts etc. may be used. The customer may order and pay either via the app or website or directly to the store. The customer may either provide delivery specifications right on the store's website using the onscreen section of the delivery system, ask to be redirected to Global Delivery app/website to give delivery specifications if the store website does not have the delivery system integrated into their website, or via telephone or the support center.

Subsequent to delivery, at step 72, users have the option to take a short survey that will serve to improve the quality of service. Users can rate service(s) received upon delivery and write comments, report problems, or make suggestions in their survey and/or post them in the blogging areas. Registered users who review products purchased will have their reviews attached to their profiles.

It should be understood that users can place an order with a single store, with multiple stores, or they can place many orders with one store and/or multiple orders with multiple stores. Users can customize the delivery of merchandise according to their preferences. Users have no limitations as to where they can purchase, although delivery is faster and more affordable if one purchases within one's regular delivery area. Users can also order directly from the store via phone or via web or they can order directly from the Global Delivery System Application 12, or by using the PC DSSAD 22 or the Mobile DSNSAD 32.

Users have the choice of inputting an address or allowing the PC DSSAD 22 or the Mobile DSNSAD 32 to locate/determine their location to obtain the stores that are within their regular delivery area. Likewise, users may also choose to purchase at stores that are outside their regular delivery area. Users can also order directly from the store via phone or via web or order directly from the PC DSSAD 22 or the Mobile DSNSAD 32 or a Global Delivery System Application 12 website/web browser. The objective of the disclosed invention is to provide users with unlimited options when it comes to ordering and delivering. Users can choose to make their purchase(s) from any store as long as the store exists; they will receive the merchandise ordered without location being a problem.

In an exemplary embodiment, image recognition capability may be provided so that, if the user takes a picture or video footage of a desired item, the PC DSSAD 22 or the Mobile DSNSAD 32 would respond by recognizing the item image, and may add the imaged item to the matching category on the user's list. There may also be provided “list management tools” and tags of every previously-selected item, or of every item of interest to the user, either for easy reordering or for keeping tabs on spending. The user is able to select a single local store, or multiple local stores, as desired.

The PC DSSAD 22 and the Mobile DSNSAD 32 may further function to incorporate electronic coupons by automatically synchronizing and applying coupon selections to the virtual cart without the user having to remember to use print out the coupon. This method would function to use electronic coupons in the global delivery system 10, thus mitigating the harvesting of trees and potentially decreasing pollution.

When a complete order is received, it may travel via the global delivery server 16 and may be transmitted directly either to the store server or to a boot receiver/or an office either inside the store, outside the store, connected or not connected to the store where the order is fulfilled, meticulously packed and dispatched for prompt delivery. The store can also choose to do the fulfilling and packaging. The order is saved to allow for prompt future re-ordering. The customers' information is safely kept in the global delivery database 14 for adequate and permitted use such as internal email and newspaper subscription, survey and market study etc. Part or all of the global delivery system application 12 software memory may be stored in the cloud 18.

In an exemplary illustration, Ms. Ellis is a 28-year-old new mother who was just released from the hospital after giving birth a week earlier via C-section. Her husband works overseas and was not able to stay with her after her release from the hospital. She is still in excruciating pain from the C-section; she can hardly move and she lives alone. Unfortunately for Ms. Ellis, she has no immediate relative close by to help her and she does not have the financial means to afford a housekeeper. Inevitably, she needs groceries and a few other items from the store, and she needs to fill her pain medication prescription.

One can imagine how difficult this situation is for her. To go to the store, she would have to take the baby with her, which would involve actually carrying the child or dealing with a car seat. Well, these tasks are quite difficult at the moment, considering her pain. Imagine how grateful she would be to know that she does not have to leave her house. She can shop from the comfort of her house using the Global Delivery System Application 12 via the PC DSSAD 22 or the Mobile DSNSAD 32 to seamlessly shop for everything she needs and have goods delivered to her door immediately.

If she wants to be very specific, she can take picture of an item she likes and upload it right next to the product/item's name. She can also ask to confirm a rare product via video chat and in this case the associate or dispatcher specialist assigned to her order would show her in real time the desired product (s). She can even order ice cream if she wants to, because it will reach her quickly enough so that she can enjoy it before it thaws.

In another example, Mr. Moore is traveling to Asia in a week. He is a very organized man. He likes to save time and schedule in advance. Before he leaves for Asia, he uses the Global Delivery System Application 12 to shop in advance for the things he needs and schedule delivery to be made to his hotel apartment in a week. Mr. Moore has some shirts at the dry cleaner near his neighborhood, but he is in a meeting and will not have the time to pick them up before the dry cleaner closes. He again uses the Global Delivery System Application 12, or the PC DSSAD 22 or the Mobile DSNSAD 32, to have his shirts picked up and delivered.

It can be appreciated by one skilled in the relevant art that the present invention is enabled by ulitizing the PC DSSAD 22 or the Mobile DSNSAD 32 disclosed above. That is, the customer is able to complete the requisite tasks and provide the customer with the useful tool and app described above.

In an exemplary embodiment, the global delivery database 14 may include actual virtual stores identical to the real stores which would allow users to shop exactly like they would physically shop by performing virtual actions such as going from aisle to aisle, moving items from virtual shelves or racks to their virtual carts or baskets. This advantage is a goal of the Global Delivery System Application 12, along with the goal of eliminating the current Wi-Fi restrictions that could impair the ability of users to virtually order while on the road, which would be in addition to the offline option. For this reason, one important and immediate objective is to enable users to anytime and anywhere have Wi-Fi access to the Global Delivery System Application 12 for the purpose of ordering and delivering via a Wi-Fi network operated by the Global Delivery System Application 12, or via a dedicated Wi-Fi network.

Also if/when human and machine/computer become one, this would complement the aspects of the present invention, since this feature would negate the necessity of having to physically access the Global Delivery System Application 12 to order, and orders would be done automatically.

Likewise, if and when robotic systems can efficiently perform tasks usually performed by humans, the Global Delivery System Application 12 can be automated for delivery, taking orders, dispatching, filling orders, and responding to inquiries. This would remove the burden from humans and makes the Global Delivery System Application 12 even more efficient.

In an exemplary embodiment, these features would improve the process as the PC DSSAD 22 or the Mobile DSNSAD 32 would be downloaded or pre-downloaded to immobile devices such as stove, microwave ovens, or any other machines, equipment, or surfaces with the capability of receiving the Global Delivery System Application 12. Also, the PC DSSAD 22 and the Mobile DSNSAD 32 can be contained in its own individual device or terminal.

In addition, there would be provided the capacity to help users arrange to have errands performed. That is, to arrange to have errands run which are not exclusive to the activity of shopping. These are all goals/plans which may be implemented in conjunction with the practice of the present invention. With this invention, essentially all commercial establishments, with or without an online presence, may become accessible to users.

It is to be understood that the description herein is only exemplary of the invention, and is intended to provide an overview for the understanding of the nature and character of the disclosed global delivery service, the PC DSSAD 22, and the Mobile DSNSAD 32. The accompanying drawings are included to provide a further understanding of various features and embodiments of the method and devices of the invention which, together with their description serve to explain the principles and operation of the invention.

What is claimed is:

1. A global delivery system comprising:
a customer global delivery system access device having installed therein a global delivery system app, said customer global delivery system access device further having Internet access functionality for initiating a commercial establishment and service provider shopping event using said global delivery system app; said global delivery system app having access to a global delivery system database of merchants participating in said global delivery system;
a global delivery server storing said global delivery system database, said global delivery server in communication with said customer global delivery system access device via the Internet; and
at least one merchant terminal providing a merchant website, said merchant website having an integrated global delivery system API for responding to said commercial establishment and service provider shopping event using said global delivery system app, said global delivery system API enabling a customer to access said global delivery system app directly on a merchant order entry web interface so as to provide the customer with access to selected merchant items.

2. The global delivery system of claim 1 wherein said database of merchants participating in said global delivery system comprises at least one of a department store, a retail store, a grocery store, a pharmacy, a restaurant, a fast-food establishment, and a coffee shop.

3. The global delivery system of claim 1 wherein said global delivery system app enables the customer to pay for an order via said global delivery system app.

4. The global delivery system of claim 1 wherein said global delivery system app enables a customer to place an order manually at a computer device, vocally at said computer device, by using a telephone, or by using a communication device.

5. The global delivery system of claim 1 wherein said global delivery system app enables a customer to provide instructions as to how a delivery is to be made.

6. The global delivery system of claim 1 wherein said global delivery system app determines the location of a customer by one of using a postal code entered by the customer or by determining the GPS coordinates of said customer global delivery system access device.

7. The global delivery system of claim 1 wherein said global delivery system app functions to display said merchants participating in said global delivery system on said customer global delivery system access device in response to the customer entering the name of a city.

8. A method of executing a global shopping event by a customer, said method comprising the steps of:
accessing a global delivery system database of commercial establishments and service providers located throughout the world;
determining the geographic location of the customer using a global delivery system app;
analyzing said global delivery system database to generate a plurality of said commercial establishments and service providers that are proximate to said geographic location of the customer;
displaying to the customer said plurality of commercial establishments and service providers using said global delivery system app;
selecting at least one of said commercial establishments and service providers as being of interest to the customer; and
reviewing a plurality of items and services offered by at least one of said commercial establishments and service providers of interest using said global delivery system app.

9. The method of claim 8 further comprising the step of placing an order, using said global delivery system app, for at least one of said plurality of items and services.

10. The method of claim 8 wherein said step of placing an order comprises the step of specifying a method of delivery for said at least one of said plurality of items and services.

11. The method of claim 8 further comprising the step of using said global delivery system app to monitor delivery of said placed order.

12. A method of executing a global shopping event by a customer, said method comprising the steps of:
accessing a global delivery system database of commercial establishments and service providers located throughout the world;
determining the geographic location of the customer using a global delivery system app;
entering at least one item desired for purchase using said global delivery system app;
retrieving a plurality of said commercial establishments and service providers that are proximate to said geographic location of the customer in response to said step of entering;
selecting at least one of said commercial establishments and service providers as being of interest to the customer; and
reviewing a plurality of items and services offered by at least one of said commercial establishments and service providers of interest using said global delivery system app.

13. The method of claim 12 further comprising the steps of placing an order for at least one of said plurality of items and services, and specifying a method of delivery for said at least one of said plurality of items and services, using said global delivery system app.

14. The method of claim 12 further comprising the step of generating a list of selected said items and services, using said global delivery system app.

15. The method of claim 14 further comprising the step of synchronizing said generated list of selected said items and services with another customer.

16. The method of claim 12 further comprising the step of programming a future delivery and future payment for at least one of said plurality of items and services, using said global delivery system app.

17. The method of claim 12 wherein said step of entering at least one item desired for purchase comprises the steps of adding a UPC-coded item to a search inquiry and using an integrated virtual Bar code scanner to scan a physical item.

18. The method of claim 12 wherein said step of entering at least one item desired for purchase comprises the step of automatically incorporating an electronic coupon by synchronizing and applying a coupon selection to a virtual cart, using said global delivery system app.
